(19) United States
(12) Patent Application Publication
(10) Pub. No.: US 2009/0099027 A1
(43) Pub. Date: Apr. 16, 2009

(54) Methods of Modifying Support Surfaces for the Immobilization of Particles and the Use of the Immobilized Particles for Analyzing Nucleic Acids

(75) Inventors: Douglas P. GREINER, Fremont, CA (US); Jeremy STUART, Charlotte, NC (US); Meng C. TAING, Hayward, CA (US); Steven M. MENCHEN, Fremont, CA (US)

Correspondence Address: MILA KASAN, PATENT DEPT.;APPLIED BIOSYSTEMS, 850 LINCOLN CENTRE DRIVE, FOSTER CITY, CA, 94404, US

(73) Assignee: APPLIED BIOSYSTEMS INC., Foster City, CA (US)

(21) Appl. No.: 12/197,132

(22) Filed: Aug. 22, 2008

Related U.S. Application Data
(60) Provisional application No. 60/935,649, filed on Aug. 23, 2007.

(51) Int. Cl. C40B 20/04; C40B 50/18; C40B 40/04

(52) U.S. Cl. 506/4; 506/32; 506/15

(57) ABSTRACT

Methods of modifying a nucleophilic surface of a support are described. The methods involve reacting a multifunctional electrophilic reagent with nucleophilic groups on the surface of the support. The resulting electrophilic surface can be used for the covalent attachment of particles (e.g. beads) having nucleophilic functional groups. For example, nucleic acid templates with nucleophilic (e.g., amine) groups can be attached to a surface of the particles. The nucleophilic groups on the nucleic acid templates can then be used to attach the particles to the modified surface of the support. The resulting support-bound particles can be used to analyze (e.g., sequence) the nucleic acid templates on the particles.

### FIELD

This application relates generally to methods of modifying surfaces for the immobilization of particles.

### INTRODUCTION

Nucleic acid sequencing techniques are widely employed in basic research. In addition, sequencing techniques are becoming increasingly important in clinical diagnosis. For example, diagnostic tests based upon particular sequence variations are already in use for a variety of different diseases. Data obtained from nucleic acid sequencing can be used to determine if a particular polynucleotide differs in sequence from a reference polynucleotide. Sequencing data can also be used to confirm the presence of a particular polynucleotide sequence in a sample, determine partial sequence information and determine the identity and order of nucleotides within a polynucleotide.

There still exists a need for more rapid and accurate methods of sequence determination.

### SUMMARY

A method is provided that comprises:

reacting a nucleophilic group on the surface of a substrate with a molecule comprising a plurality of electrophilic groups thereby providing one or more free electrophilic groups on the surface of the substrate; and

reacting nucleophilic groups on a surface of a particulate material with the one or more free electrophilic groups on the surface of the substrate to covalently attach the particulate material to the substrate.

An article of manufacture is also provided that comprises:

a particulate material comprising surface functional groups;

a support comprising surface functional groups;

wherein surface functional groups of the particulate material are covalently attached to surface functional groups on the support via a linker group comprising the moiety:

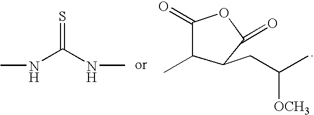

A method is also provided that comprises:

reacting a nucleophilic group on the surface of a substrate with the compound represented by the formula:

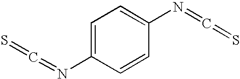

or a polymer having a moiety represented by the formula:

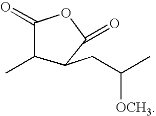

An article of manufacture is also provided that comprises a moiety covalently attached to a support surface, wherein the moiety is represented by the formula:

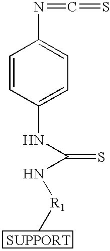

wherein R₁ represents a linking group and “SUPPORT” represents the support surface; or

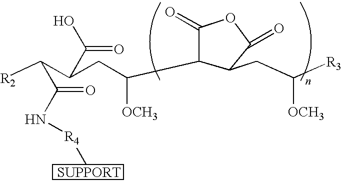

wherein n is a positive integer, “SUPPORT” represent the support surface, R₂ is a first chemical group, R₃ is a second chemical group and R₄ is a linker group.

A method is also provided that comprises:

(a) hybridizing an initializing oligonucleotide probe to a target polynucleotide to form a probe-target duplex, wherein the oligonucleotide probe has an extendable probe terminus, wherein the target polynucleotide is attached to a particulate material and wherein the particulate material is covalently attached to the surface of a support;

(b) ligating a first end of an extension oligonucleotide probe to the extendable probe terminus thereby forming an extended duplex containing an extended oligonucleotide probe, wherein the extension oligonucleotide probe comprises a cleavage site and a detectable label;

(c) identifying one or more nucleotides in the target polynucleotide by detecting the label attached to the just-ligated extension oligonucleotide probe;

(d) cleaving the just-ligated extension oligonucleotide probe at the cleavage site to generate the extendable probe terminus, wherein cleavage removes a portion of the just-ligated extension oligonucleotide probe that comprises the label from the probe-target duplex; and

(e) repeating steps (b), (c) and (d).

A method of sequencing a nucleic acid is also provided which comprises:

(a) hybridizing a primer to a target polynucleotide to form a primer-target duplex, wherein the target polynucleotide is attached to a particulate material at a 5′ end and wherein the particulate material is covalently attached to the surface of a support;

(b) contacting the primer-target duplex with a polymerase and one or more different nucleotide analogs to incorporate a nucleotide analog onto the 3′ end of the primer thereby forming an extended primer strand, wherein the incorporated nucleotide analog terminates the polymerase reaction and wherein each of the one or more nucleotide analogs comprises (i) a base selected from the group consisting of adenine, guanine, cytosine, thymine and uracil and their analogs (ii) a unique label attached to the base or analog thereof via a cleavable linker; (iii) a deoxyribose; and (iv) a cleavable chemical group which caps an —OH group at a 3′-position of the deoxyribose;

(c) washing the surface of the support to remove any unincorporated nucleotide analogs;

(d) detecting the unique label attached to the just-incorporated nucleotide analog to thereby identify the just-incorporated nucleotide analog;

(e) optionally, permanently capping any unreacted —OH group on the extended primer strand;

(f) cleaving the cleavable linker between the just incorporated nucleotide analog and the unique label;

(g) cleaving the chemical group capping the —OH group at the 3′-position of the deoxyribose of the just incorporated nucleotide analog to uncap the —OH group;

(h) washing the surface of the support to remove cleaved compounds;

(i) repeating steps (b)-(h).

These and other features of the present teachings are set forth herein.

### BRIEF DESCRIPTION OF THE DRAWINGS

The skilled artisan will understand that the drawings, described below, are for illustration purposes only. The drawings are not intended to limit the scope of the present teachings in any way. The patent or application file contains at least one drawing executed in color. Copies of this patent or patent application publication with color drawing(s) will be provided by the Office upon request and payment of the necessary fee.

FIG. 1 is a schematic illustrating the conversion of a nucleophilic surface to an electrophilic surface using multifunctional electrophilic reagents.

FIG. 2A is a schematic illustrating a reaction scheme for conversion of a nucleophilic surface to an electrophilic surface using a bifunctional electrophilic reagent.

FIG. 2B is a schematic illustrating a reaction scheme for conversion of a nucleophilic surface to an electrophilic surface using a polymeric multifunctional electrophilic reagent.

FIG. 3 is a bar graph demonstrating the effect of salt and DMSO concentration on P1 oligonucleotide coupling efficiency.

FIG. 4 is a bar chart that illustrates the optimization of reaction conditions for thioureayl formation between amine and isothiocyanate groups wherein various amine and carboxylic acid beads were incubated with 200 μM FITC solution at different pH and temperature conditions.

FIG. 5 is a bar chart showing PDITC-activated slides incubated with fluorescent-labeled cadaverine in the presence or absence of ethanolamine.

FIGS. 6A-6C are photographs illustrating PDITC-activation results for loss of free amine on slides.

FIG. 7 are photographs illustrating TdT-mediated addition of aminoallyl-dUTP to DNA templates.

FIG. 8 is a bar chart providing a quantitative measurement of amine content on beads after different TdT-extension times.

FIG. 9A is a photograph illustrating the attachment of TdT-extended beads to PDITC-activated slides showing little or no bead movement.

FIG. 9B is a photograph illustrating the attachment of beads that were not TdT-extended to PDITC-activated slides showing significant bead movement.

FIG. 10 is a graph showing the % beads remaining as a function of sequencing cycle number for TdT-extended beads deposited on PDITC-activated slides showing that the beads remain stable after 50 cycles of sequencing.

### DESCRIPTION OF THE VARIOUS EMBODIMENTS

For the purposes of interpreting this specification, the following definitions will apply and whenever appropriate, terms used in the singular will also include the plural and vice versa. In the event that any definition set forth below conflicts with the usage of that word in any other document, including any document incorporated herein by reference, the definition set forth below shall always control for purposes of interpreting this specification and its associated claims unless a contrary meaning is clearly intended (for example in interpreting the document where the term is originally used). The use of “or” herein means “and/or” unless stated otherwise or where the use of “and/or” is clearly inappropriate. The use of “a” herein means “one or more” unless stated otherwise or where the use of “one or more” is clearly inappropriate. The use of “comprise,” “comprises,” “comprising,” “include,” “includes,” and “including” are interchangeable and not intended to be limiting Furthermore, where the description of one or more embodiments uses the term “comprising,” those skilled in the art would understand that, in some specific instances, the embodiment or embodiments can be alternatively described using the language “consisting essentially of” and/or “consisting of.”

As used herein, the term “nucleoside” includes 2′ deoxy nucleosides and 2′-hydroxyl nucleosides. The term “analogs” in reference to nucleosides includes synthetic nuceosides having modified base moieties and/or modified sugar moieties. Such analogs include synthetic nucleosides designed to enhance binding properties, reduce degeneracy, increase specificity, and the like.

As used herein, the phrase “nucleotide analog” refers to a chemical compound that is structurally and functionally similar to a nucleotide and which can be recognized by a polymerase as a substrate. Nucleotide analogs include nucleotides comprising labels attached to the nucleotide via a cleavable linker and nucleotides in which the —OH group at the 3′ position of the deoxyribose is capped (e.g., with a chemical moiety such as —CH₂OCH₃ or —CH₂CH═CH₂). Nucleotide analogs of this type are disclosed in U.S. Pat. No. 6,664,079 B2.

As used herein, to cap (or capping) an —OH group means to replace the hydrogen of the —OH group with a different chemical group. The —OH group can be capped with a cleavable chemical group. To uncap (or uncapping) means to cleave the chemical group from a capped —OH group and to replace the chemical group with “H”. Suitable means of capping and uncapping —OH groups are disclosed in U.S. Pat. No. 6,664,079 B2.

As used herein, the phrase “oligonucleotide” refers to a linear oligomer of nucleosides or analogs thereof, including deoxyribonucleosides, ribonucleosides and the like. Oligonucleotides can range in size from a few monomeric units (e.g., 3 to 4 units) to several hundred monomeric units.

As used herein, the term “ligation” refers to covalent bond formation or linkage between the termini of two or more nucleic acids (e.g., oligonucleotides or polynucleotides).

As used herein, the phrase “extendable probe terminus” refers to a terminus of a nucleic acid to which another nucleic acid can be ligated.

As used herein, the phrase “non-extendable probe terminus” refers to a terminus of a nucleic acid to which another nucleic acid cannot be ligated without modification. For example, the terminus may be a nucleotide that lacks a 5′ phosphate or a 3′ hydroxyl group. Alternatively, the terminus may be a nucleotide residue with a blocking group attached that prevents ligation.

As used herein, the phrase “universal base” refers to a base that can pair with more than one of the bases typically found in naturally occurring nucleic acids and that can thus substitute for naturally occurring bases in a duplex. The base need not be capable of pairing with each of the naturally occurring bases. Universal bases are described in International Publication No. WO 2006/084132 A2.

As used herein, the phrase “surface functional groups” refers to functional groups that are attached to a surface. These groups can be attached directly to the surface or indirectly to the surface via a linking group.

As used herein, the term “particle” and the phrase “particulate material” are used interchangeably and refer to any solid body having finite mass and internal structure. Exemplary particles include beads and microspheres. According to some embodiments, the particles can have a diameter of less than 100 μm (e.g, 1 μm). Particles can be made of a variety of materials including polymers (e.g., polystyrene), glass and ceramics. Other exemplary particles include magnetic particles. Suitable magnetic particles include, but are not limited to, those disclosed in U.S. Pat. No. 5,512,439. For example, the magnetic particles can be monodisperse superparamagnetic beads produced according to EP 83901406.5 wherein the term “monodisperse” encompasses size dispersions having a diameter standard deviation of less than 5%. The monodisperse particles can have a specific gravity in the range 1.1 to 1.8 or 1.2 to 1.5. The monodisperse particles can be spherical beads having a diameter of at least 1 and not more than 10 microns or at least 2 and not more than 6 microns in diameter (e.g. about 3 microns in diameter).

Sequencing by Oligonucleotide Ligation and Detection (SOLiD™) involves attachment of DNA target to a small, insoluble structure (e.g., a 1 micron diameter cross-linked polystyrene bead) followed by immobilization of a plurality of the structures, where each structure comprises a unique DNA sequence, onto a flat surface. Sequencing techniques of this type are disclosed in International Publication No. WO 2006/084132 A2.

Methods of attachment of the beads to the support have utilized a flat glass microscope slide irreversibly coated with streptavidin DNA laden polystyrene bead with biotinylated nucleotides (e.g., obtained by the action of biotinylated dNTP's and terminal deoxytransferase on the DNA target subsequent to attachment to the bead). Incubation of the biotinylated beads with the streptavidin coated slide results in immobilization of the beads onto the slide by the interaction of streptavidin with the biotin. While kinetically this is a very effective attachment scheme, movement of the beads on the slide was sometimes observed under the conditions required by the DNA sequence assay. When beads are present in high densities on the slide (e.g., up to 100,000 beads/mm²) and interrogated multiple times (e.g., up to 25 times), any significant bead movement can preclude robust identification of a particular bead on subsequent scans within a dense population of beads.

As described herein, a covalent system for bead immobilization has been developed that reduces movement of the beads during sequencing and other forms of genetic analysis. A method is provided that comprises: reacting a nucleophilic group on the surface of a substrate with a molecule comprising a plurality of electrophilic groups thereby providing one or more free electrophilic groups on the surface of the substrate; and reacting nucleophilic groups on a surface of a particulate material with the one or more free electrophilic groups on the surface of the substrate to covalently attach the particulate material to the substrate.

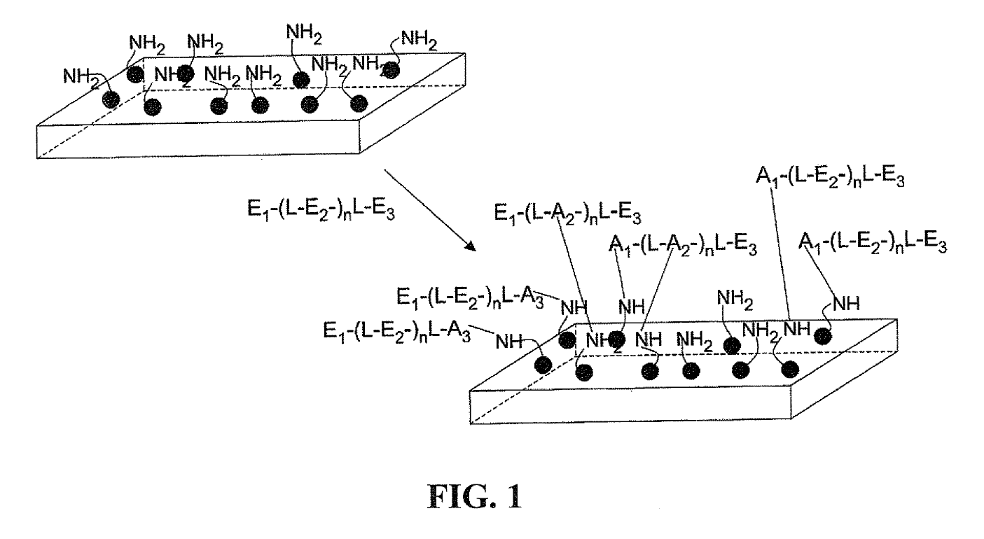

FIG. 1 demonstrates the modification of a nucleophilic (i.e., amino functional) surface with a multifunctional electrophilic reagent. As shown in FTG. 1, the nucleophiles on the surface are amino groups. These nucleophilic amino groups can be formed on an electrophilic surface. For example, the electrophilic surfaces of silicate glass microscope slides an be readily converted to a nucleophilic surface by reacting surface groups with (aminopropyl) trialkoxysilanes).

As shown in FIG. 1 the surfaces were activated with molecules containing multiple electrophiles, where one of the electrophilic groups on the electrophilic molecule reacts to form a stable covalent bond with the nucleophilic partner on the slide surface, and the residual electrophile or electrophiles on the molecule is/are available to react with and form a stable covalent bond with a nucleophilic group on the particle that is desired to be immobilized. In FIG. 1, the electrophiles in the molecules are represented by E₁, E₂ and E₃ and the electrophile in the molecule that reacts with the nucleophile on the surface is represented by A₁, A₂ or A₃, respectively.

As described below, a DNA target nucleic acid that had been covalently attached to a 1 micron cross-linked polystyrene bead was modified by the action of aminoalkyl dNTP's and terminal deoxytransferase on the DNA target subsequent to attachment to the bead. The nucleophilic amino group on the DNA target could then react with the residual electrophilic group of the support surface to form multiple stable covalent bonds between the bead and the glass surface.

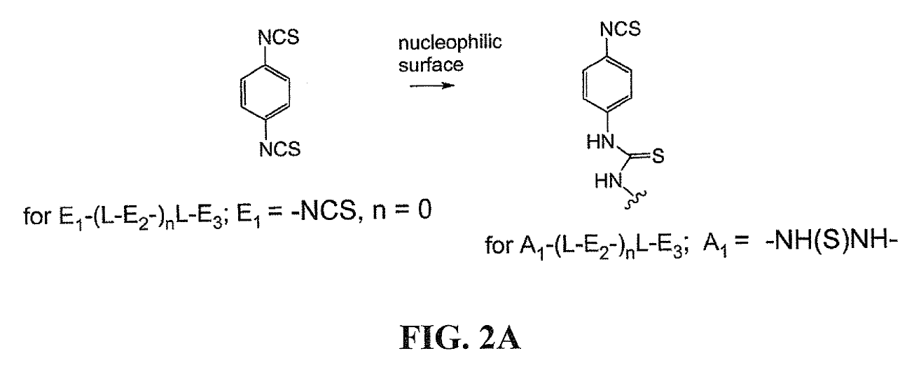

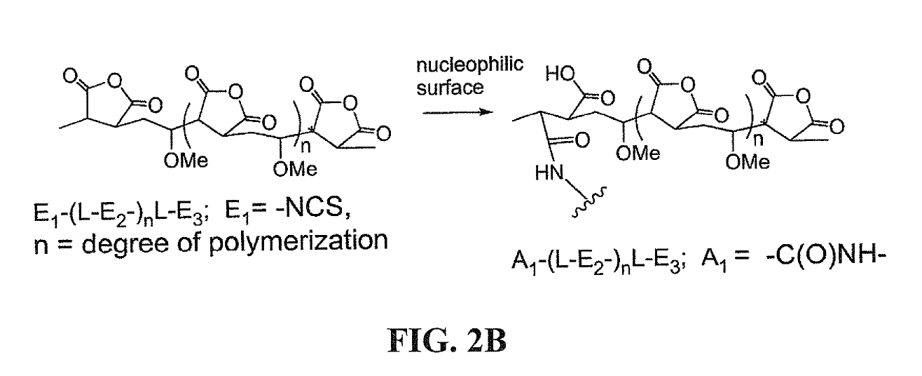

Some examples of molecules with multiple electrophilic groups that can be used to bridge the electrophilic surface with the electrophilic bead are shown in FIGS. 2A and 2B. FIG. 2A illustrates modification of an electrophilic surface via reaction of the electrophilic groups on the surface with benzene 1,4-diisothiocyanate. For benzene 1,4-diisothiocyanate {using the nomenclature of E₁-(L-E₂)ₙL-E₃}, E₁ and E₃ are electrophilic groups that are the same (i.e., isothiocyanate groups), the linking group L is a benzene ring, and n is 0.

FIG. 2B illustrates modification of an electrophilic surface via reaction of the electrophilic groups on the surface with a copolymer of methylvinyl ether and maleic anhydride. For the copolymer of methylvinyl ether and maleic anhydride {using the nomenclature of E₁-(L-E₂-)ₙL-E₃}, the electrophilic groups E₁, E₂ and E₃ are the same (i.e., succinic anhydride groups), the linking group L is methoxyethane, and n is >0 (representing the degree of polymerization or the molecular weight of the copolymer).

Referring to FIG. 1, the reaction of Eₓ from E₁-(L-E₂-)ₙL-E₃ with a nucleophilic partner on the surface yields a stable functionality Aₓ such as A₁-(L-E₂-)ₙL-E₃ where the residual functionalities E_{y} are available to react with nucleophilic functionalities on the bead to be immobilized. The resulting surface containing A₁-(L-E₂-)ₙL-E₃ is referred to as the “activated surface”. As shown in FIG. 2A, Aₓ is thiourea for benzene 1,4-diisothiocyanate. As shown in FIG. 2B, Aₓ is amide for copolymer of methylvinyl ether and maleic anhydride.

When the activated surface containing electrophilic groups is contacted with a particle containing nucleophilic groups, the linkage between the particle and the surface can be characterized as A₁-(L-E₂-)ₙL-A₃ where at least one of Aₓ forms a stable covalent linkage to the surface, and at least one of Aₓ forms a stable covalent linkage to the microstructure. For the case of benzene 1,4-diisothiocyanate shown in FIG. 2A linking an amino surface with a bead containing nucleophilic amino groups on a DNA target, all of Aₓ will be thiourea linkages. For the case of the copolymer of methylvinyl ether and maleic anhydride shown in FIG. 2B linking an amino surface with a bead containing nucleophilic amino groups on a DNA target, all of A will be amide linkages.

It has been found that stable covalent bonds can be formed between a surface containing electrophilic groups and particles containing nucleophilic groups. In addition, beads containing nucleophilic amino groups from the action of amino-dNTP's and terminal deoxytransferase on a DNA target can be immobilized under aqueous basic conditions on the modified surface. For example, surfaces comprising amino groups that have been activated with benzene 1,4-diisothiocyanate can be used to immobilize beads with nucleophilic groups. In addition, the covalent attachment appears to be quite stable, and no bead movement is observed.

The surface immobilized beads described herein can be used in methods of analyzing nucleic acid sequences based on repeated cycles of duplex extension along a single stranded template via ligation. Sequencing methods of this type are disclosed in U.S. Pat. Nos. 5,750,341; 5,969,119; and 6,306,597 B1 and in International Publication No. WO 2006/084132 A2. Each of these publications is incorporated by reference herein in its entirety. Moreover, the techniques described in the aforementioned publications can be used to analyze (e.g., sequence) nucleic acid templates attached to particles that are bound to supports as described herein. The immobilized beads can be used in sequencing methods that do not necessarily employ a ligation step, such as sequencing using labeled nucleotide that have removable blocking groups that prevent polynucleotide chain extension (e.g., U.S. Pat. Nos. 6,664,079; 6,232,465; and 7,057,026. The immobilized beads can be used in a variety of techniques in which signals on the beads are repeated detected through multiple cycles.

For example, a method is provided that comprises:

(a) hybridizing a first initializing oligonucleotide probe to a target polynucleotide to form a probe-target duplex, wherein the oligonucleotide probe has an extendable probe terminus, wherein the target polynucleotide is attached to a particulate material and wherein the particulate material is covalently attached to the surface of a solid support;

(b) ligating a first end of an extension oligonucleotide probe to the extendable probe terminus thereby forming an extended duplex containing an extended oligonucleotide probe, wherein the extension oligonucleotide probe comprises a cleavage site and a detectable label;

(c) identifying one or more nucleotides in the target polynucleotide by detecting the label attached to the just-ligated extension oligonucleotide probe;

(d) cleaving the just-ligated extension oligonucleotide probe at the cleavage site to generate the extendable probe terminus, wherein cleavage removes a portion of the just-ligated extension oligonucleotide probe that comprises the label from the probe-target duplex; and

(e) repeating steps (b), (c) and (d) until a sequence of nucleotides in the target polynucleotide is determined.

The cleavage site can be cleaved under conditions that will not cleave phosphodiester bonds. Cleavage can therefore occur under conditions that will not cleave the phosphodiester bonds of the extended oligonucleotide probe.

The detectable label can be a fluorescent moiety.

A second end of the extension oligonucleotide probe opposite the first end can comprise a non-extendable probe terminus. This prevents multiple ligations from occurring during a single cycle.

The extension oligonucleotide probe can be an octamer. The oligonucleotide probe can have a sequence as set forth below:

*NNNNN-zzz

wherein each “N” represents, independently, A, C, T or G, “z” represents a universal base, “*” represents the ligation site and “-” represents the cleavage site. The detectable label can be attached to one of the universal bases.

According to some embodiments, four different categories of probes can be used, each having a different label:

*NNNTA-zzz;

*NNNGG-zzz;

*NNNTC-zzz; and

*NNNAT-zzz.

According to some embodiments, the method further comprises hybridizing a second initializing oligonucleotide probe to the target polynucleotide to form a probe-target duplex and conducting steps (b), (c) and (d) repeatedly wherein the second initializing oligonucleotide probe differs by one nucleotide in length from the first initializing oligonucleotide probe. in this manner, the sequence of the target can be determined.

### Examples

Aspects of the present teachings may be further understood in light of the following examples, which should not be construed as limiting the scope of the present teachings in any way.

Conjugation of a P1 Oligonucleotide with Carboxylic Acid Polystyrene Beads

The method described below is based on activation of carboxylic groups on the beads surface with 1-Ethyl-3-[3-dimethylaminopropyl]carbodiimide hydrochloride (EDC) and in-situ coupling the formed O-acylisourea intermediate with an amino-modified oligonucleotide in the presence of imidazole, creating a covalent bond between the bead surface and the 5′ end of the oligonucleotide. Since bead capacity for the oligonucleotide molecules is limited, there are many free carboxyls left on the bead surface after P1 conjugation. These charged groups interfere with the downstream procedures by causing beads to absorb to fluorescent dyes, thus substantially increasing fluorescent noise. Also, non-capped DNA-loaded beads tend to aggregate. To inactivate these carboxyls, a second procedure, capping these groups with amino-methoxy PEG12, is performed.

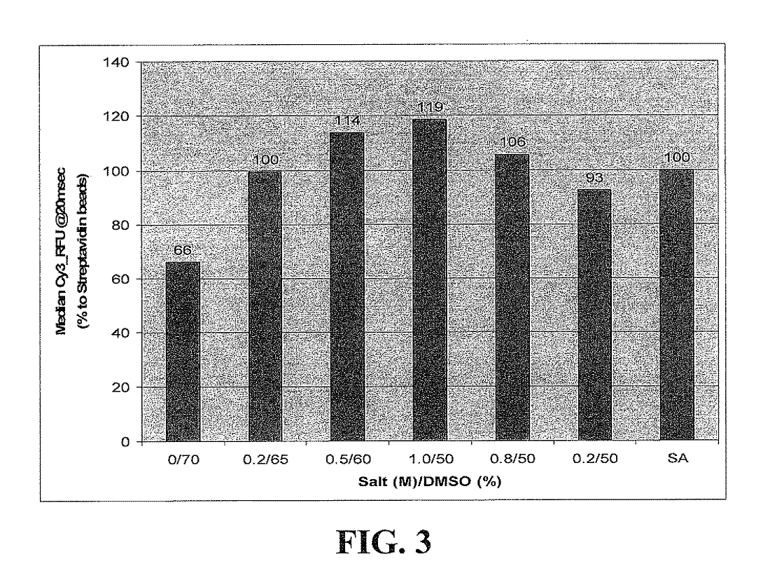

The goal of this experiment was to achieve covalent attachment of P1 oligonucleotide on carboxy beads at the same capacity as had been achieved using biotinylated P1 and streptavidin beads. That level of P1 oligonucleotide loading was sufficient for SOLiD™ ligation sequencing. However, using the conjugation system recommended by the bead manufacturer, levels of covalent P1 loading at about 70% of the streptavidin-based system were observed (data not shown). Further experimentation revealed that the presence of both NaCl and DMSO in the covalent system resulted in more efficient P1 conjugation. The effect the ratio of NaCl (“Salt”) and DMSO is illustrated in FIG. 3 which is a bar chart shown the medium Cy3 RFU at 20 msec indicated as a % to steptavidin beads for different ratios of NaCl and DMSO. As can be seen from FIG. 3, the highest RFU values were exhibited at NaCl to DMSO ratios of 0.5/60 and 1.0/50.

As shown in FIG. 3, despite high DMSO concentration (70% v/v), P1 conjugation did not increase when NaCl was absent in the system. In general, increasing NaCl concentration in a DMSO-containing system correlated with higher P1 loading on carboxy beads. Conversely, NaCl in the absence of DMSO had an inhibitory effect on P1 loading (data not shown). Based on a number of experiments, a combination of 200 mM NaCl and 50% v/v DMSO was selected for use in the P1 conjugation reaction.

A typical P1 conjugation procedure is set forth below:

An aliquot of MyOne Carboxylic Acid beads is washed once with 0.01N NaOH, and then five times with DEPC Water. A reaction mixture contains 200 mM NaCl, 0.1 mM 5′-aminomodified P1 oligonucleotide 41 bases long, 1 mM imidazole chloride, 50% v/v DMSO and 200 mM EDC. The beads are mixed well with reagents, vortexed, sonicated and incubated overnight at room temperature on a rotator. The second step (i.e., capping) is done by converting remaining carboxyls into amino-reactive NHS-ester in presence of 200 mM EDC and 50 mM NHS, with subsequent conjugation with aminoPEG12 at 20 mM.

### Development of a Covalent Bead-to-Slide Deposition Chemistry for the SOLiD™ Platform

The following describes the development of a novel covalent chemistry involving random deposition of DNA-template beads onto a modified glass surface for the SOLiD™ sequencing platform.

The development of this chemistry involves three major steps. First, optimization of thioureayl formation between amines and isothiocyanate for QC assays and bead immobilization. Second, generation of an electrophilic glass surface by activation of aminopropyl/trialkoxysilane-coated glass with 1,4-phenylenediisothiocyanate (PDITC), Third, addition of nucleophilic amines to the 3′ end of DNA templates by terminal deoxytransferase mediated addition of aminoallyl-dUTP. The development of each step will be discussed with accompanying data, followed by validation of bead immobilization that provides stability under conditions required by the DNA sequence assay.

### Determination of Optimal Reaction Conditions for Formation of Covalent Thioureayl Bonds Between Amine and Isothiocyanate Functional Groups

Proper reaction of amines with isothiocyanate moieties results in thioureayl bond formation, a covalent attachment that is very stable. To determine the optimal conditions for thioureayl bond formation, one of the components in this reaction was fluorescently labeled and used as a reporter. Specifically, these assays used fluorescein-labeled isothiocyanate (FITC). Optimization of this reaction condition not only ensured proper covalent attachment of the bead to the slide but provided quality checkpoints for generating nucleophiles on the bead and electrophilic groups on the slide prior to bead immobilization.

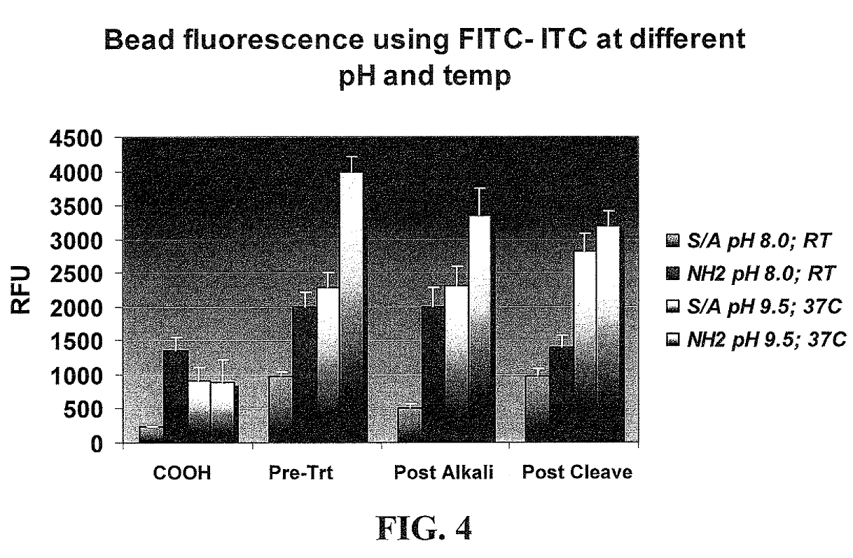

To optimize the reaction conditions, chemistry was performed on beads known to have high amine content on their surface. These beads were reacted with FITC in various buffer types while varying the temperature and pH. Bead fluorescence attributed to the covalent attachment of the fluorescein-labeled isothiocyanate group to amines was measured and compared between different reaction conditions. To ensure covalent bond formation, fluorescence was measured after the same beads were treated with alkali and heavy metal solutions (similar to conditions seen in certain cycles of SOLiD™ sequencing). The abbreviated results from these experiments are shown in FIG. 4. As shown in FIG. 4, at higher pH (9.5) and heat (37° C.), both streptavidin and amine-beads exhibit FITC-signal far greater than exhibited at low pH and at room temperature. As also shown in FIG. 4, FITC-signal is specific for amine-containing beads as carboxylic acid beads (COOH) display much lower signal in comparison. Finally, FITC remains present after alkali and heavy metal (cleave) treatments, indicating robust FITC-binding to beads. These studies provided the foundation for activating the slide surface with electrophiles and assessing amine content on beads for attachment to the slide.

### Activation of a Modified Glass Slide to Generate an Electrophilic Surface for Bead Immobilization

The successful covalent attachment of oligonucleotides to glass supports using PDITC chemistry has been previously reported {Guo et al., Direct Fluorescence Analysis Of Genetic Polymorphisms By Hybridization With Oligonucleotide Arrays On Glass Supports, Nucleic Acids Res. 22(24):5456-65 (1994)}. Experiments were conducted to determine whether these methods could be applied to covalent attachment of 1-micron beads to a modified glass surface. Nucleophilic glass surfaces are commercially available in the form of amine-coated silicate slides that are easily generated by immersing slides in a solution containing (aminopropyl)trialkoxysilanes. These were purchased from various vendors and the relative amine content on each slide was determined by incubating each slide in 200 μM FITC solution, followed by visualization under a fluorescent microscope. After comparing fluorescence on each slide type, it was decided to continue our work using Schott A+ slides, as they reported the highest and most uniform distribution of ITC-mediated fluorescence.

Next, the nucleophilic moieties on the glass surface were converted to electrophiles by reacting the slides overnight in a DMSO solution containing 50 mM PDITC and 20 mM n,n-Diisopropylethylamine (DIEA). DIEA was added as a base to facilitate thioureayl formation between the primary amines and isothiocyanate moiety. Afterward, slides were washed twice with DMSO, then three times with 70% ethanol, followed by three water washes. Slides were then spun dry and stored in an electronic dessicator.

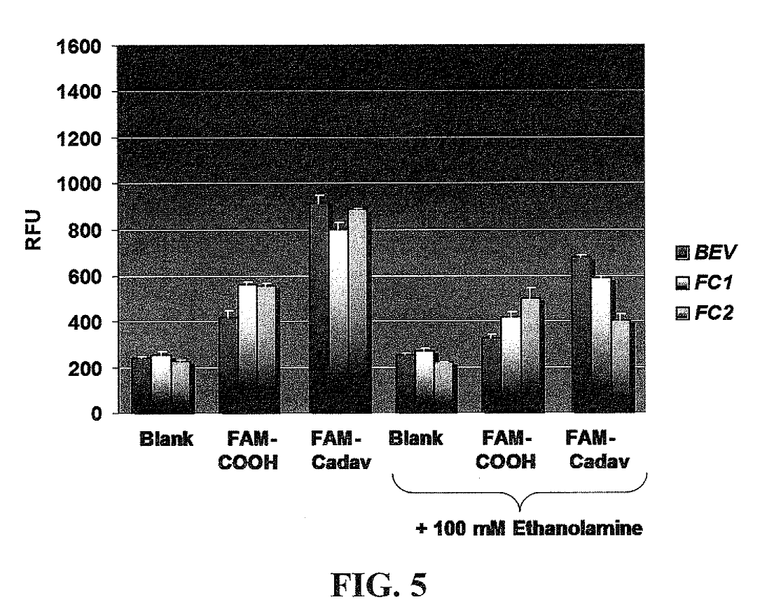

To determine whether activation of the slide surface to electrophiles was successful, slides were incubated with fluorescein-labeled cadaverine, a small and highly reactive diamine. The amount of fluorescence on the slide was measured using a fluorescent microscope. To assess background levels of fluorescence attributed to non-specific binding of the fluorescein, fluorescein-labeled carboxylic acid was included. Additionally, ethanolamine was included in a subset of incubations to see whether it could compete with cadaverine-binding to the slide. As FIG. 5 shows, PDITC-activated slides show a 150-240% increase in the amount of fluorescence after incubation with fluorescein-labeled cadaverine. This increase is attenuated by the inclusion of 100 mM ethanolamine, indicating that the electrophilic group on the slide reacts with primary amines. FIG. 5 is a bar chart showing PDITC-activated slides incubated with fluorescent-labeled cadaverine in the presence or absence of ethanolamine. Fluorescent-labeled carboxylic acid was used to provide baseline fluorescence. “BEV” indicates a PDITC activated slide made in Beverly, Mass. “FC1” and “FC2” indicate PDITC activated slides made in Foster City, Calif.

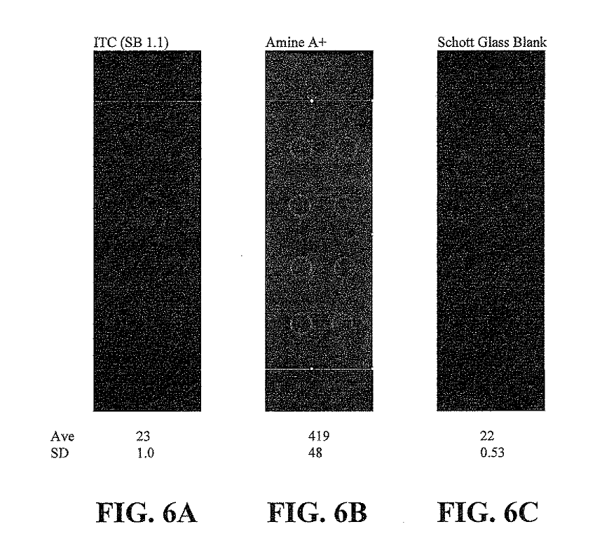

Another method of determining the reaction progression of PDITC activation involved assessing the amine content of A+ slides before and after incubation with PDITC. Slides were incubated with fluorescein-labeled isothiocyanate (FITC) and visualized on an axon scanner to assess their amine content. Comparisons were made to blank slides, A+ slides, and PDITC-activated slides. FIGS. 6A, 6B and 6C show the results. FIGS. 6A-6C are photographs illustrating PDITC-activation results for loss of free amine on slides. Blank glass, PDITC-activated, and unactivated amine slides were incubated with FAM-ITC and visualized using an axon scanner to determine the presence of free amines. Mean RFU values resulting from FITC reaction with amines are listed under each slide with the corresponding standard deviation. Both blank slides (FIG. 6C) and PDITC slides (FIG. 6A) show similarly weak RFU values, indicating an absence of amines. In contrast, unmodified A+ slides (FIG. 6B) display very high RFU values, indicating a high amine content. Thus, the PDITC activation step effectively reacts with amines on A+ slides and renders them unavailable for further modification. Moreover, PDITC-activation results in loss of free amines on A+ slides.

### Addition of Nucleophilic Amines on DNA Template Beads for Conjugation to the Electrophilic Glass Surface

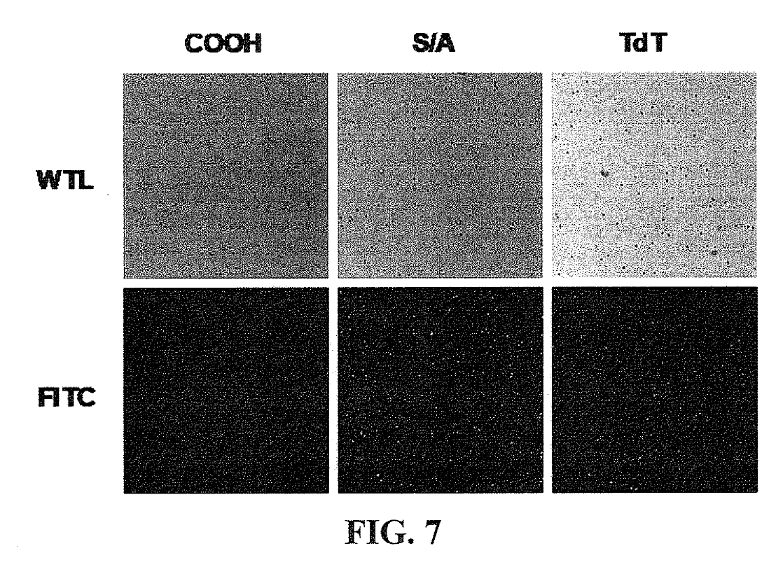

Concurrent with PDITC-activation of the silicate surface, experiments were designed to generate a nucleophilic group on the DNA template beads that would react with the electrophile present on the glass slides. Since terminal deoxytransferase (TdT) had previously been used to add biotin-labeled nucleotides to the 3′ ends of DNA templates on the bead, we decided to continue with this strategy but instead use aminoallyl-labeled dUTP as the addition substrate. The standard recipe that was recommended by the manufacturer of the terminal deoxytransferase was used. The addition of nucleophilic amines by reacting TdT-extended beads with FITC was verified. Streptavidin-coated beads (containing many amines) and carboxy beads were used as positive and negative controls, respectively. FIG. 7 shows that the streptavidin (S/A) and TdT-extended beads display ITC-mediated fluorescence due to the reaction with amines, while the carboxylic acid (COOH) beads show no signal. FIG. 7 are photographs showing FITC intensity for streptavidin (S/A) beads, carboxylic acid (COOH) beads and TdT-extended beads. The indicated bead types were incubated with fluorescein-labeled ITC to detect the presence of aminoallyl-dUTP. Beads were visualized under white-light (WTL) and FITC-exitation (FITC). In FIG. 7, “COOH” refers to carboxylic acid beads, “S/A” refers to streptavidin beads, and “TdT” refers to aminoallyl-dUTP-extended beads.

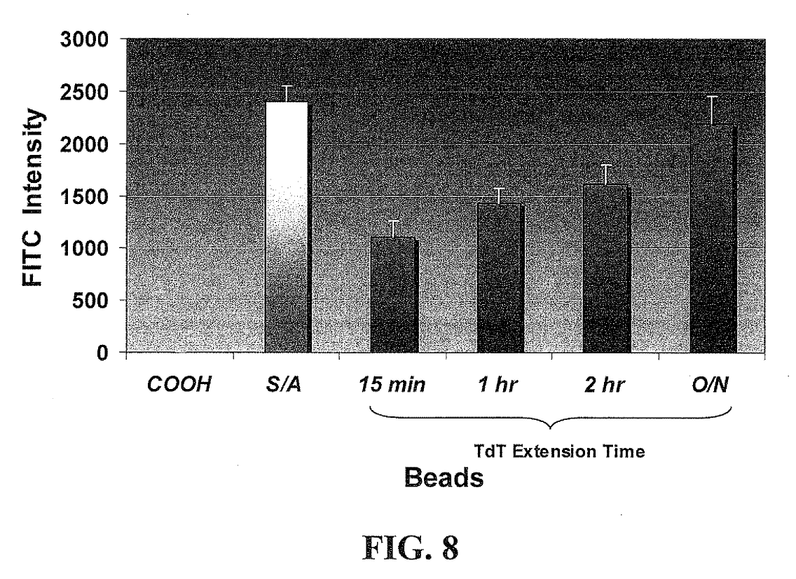

Quantitative analysis of this reaction reveals a dose-dependent increase in the amount of fluorescence as the TdT-extension is allowed to proceed longer as shown in FIG. 8. FIG. 8 is a bar chart illustrating a quantitative measurement of amine content on beads after different TdT-extension times. Beads were treated as indicated above and visualized under fluorescence microscopy for ITC-mediated fluorescence. In FIG. 8, “COOH” refers to carboxylic acid beads, “S/A” refers to streptavidin beads and “O/N” refers to overnight incubation.

### Validation of Robust Bead Attachment to PDITC-Activated Slides

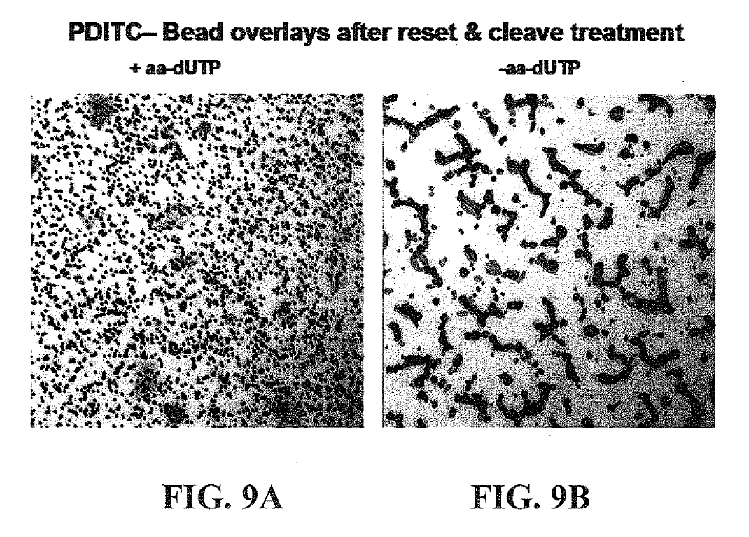

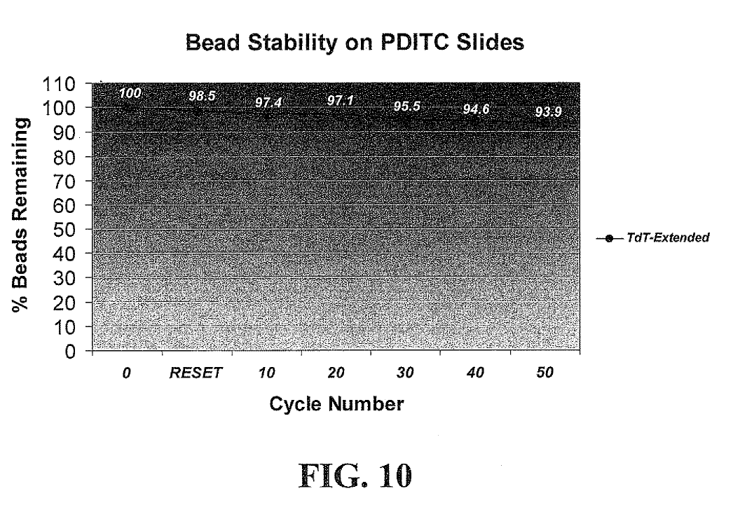

The Applied Biosystems Sequencing by Oligonucleotide Ligation and Detection (SOLiD™) platform utilizes a plurality of clonal DNA-template beads randomly distributed on a slide surface to which various cycles of biochemistry is applied. For accurate detection and registration of DNA sequences, the beads should remain immobilized for the full duration of the sequencing cycles. To demonstrate that the thioureayl attachments linking the bead to the slide can withstand SOLiD™ sequencing conditions, TdT library beads were deposited on a PDITC-activated slide and bead movement was measured after several modules of SOLiD™ sequencing. Overlay of bead images before and after treatment indicates that beads containing nucleophilic amines are stable on PDITC-activated slides (FIG. 9A) whereas beads that do not contain amines are relatively unstable (FIG. 9B). Bead movement was tracked after alkali (reset) and heavy metal (cleave) treatments. Beads prior to any treatment appear red, whereas red beads denote images taken after treatments. When bead movement is tracked over the equivalent of a full sequencing run, over 90% of the beads remain immobilized as illustrated in FIG. 10.

FIG. 10 is a graph showing the percentage (%) of beads remaining as a function of sequencing cycle number for sequencing conducted on TdT-extended beads deposited on PDITC-activated slides. As can be seen from FIG. 10, the beads remain stable even after 50 cycles of sequencing. Images were taken of beads every 10 cycles of ligation sequencing and the percentage of remaining beads was calculated. The numbers shown are the means of three independent experiments. Together, these results indicated that thioureal attachment is robust enough for the SOLiD™ platform.

While the foregoing specification teaches the principles of the present invention, with examples provided for the purpose of illustration, it will be appreciated by one skilled in the art from reading this disclosure that various changes in form and detail can be made without departing from the true scope of the invention.

What is claimed is:

1. A method comprising:
reacting a nucleophilic group on the surface of a substrate with a molecule comprising a plurality of electrophilic groups thereby providing one or more free electrophilic groups on the surface of the substrate; and
reacting nucleophilic groups on a surface of a particulate material with the one or more free Electrophilic groups on the surface of the substrate to covalently attach the particulate material to the substrate.

2. The method of claim 1, wherein the molecule comprising a plurality of electrophilic groups is represented by the following structure:
E₁-(L-E₂-)ₙL-E₃
wherein E₁, E₂ and E₃ are electrophilic groups, L is a linker and n is 0 or a positive integer.

3. The method of claim 2, wherein the molecule comprising a plurality of electrophilic groups is:

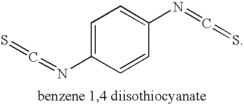

4. The method of claim 2, wherein the molecule comprising a plurality of electrophilic groups is a polymer having a repeat unit represented by the formula:

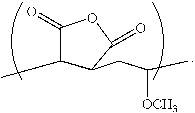

5. The method of claim 1, wherein a nucleic acid comprising nucleophilic groups and having a 5′ end and a 3′ end is attached to the surface of the particulate material.

6. The method of claim 5, wherein the nucleic acid comprises a nucleophilic group of the formula: 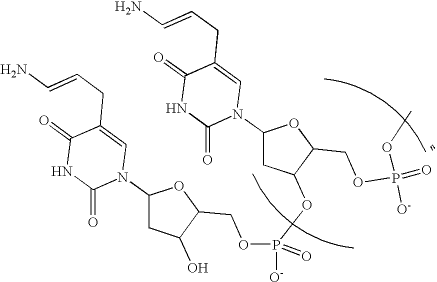
wherein n is 0 or an integer.

7. The method of claim 6, wherein the nucleic acid is attached to the particulate material via the 5′ end of the nucleic acid and wherein the nucleophilic group is at the 3′ end of the nucleic acid.

8. The method of claim 1, wherein the particulate material comprises cross-linked polystyrene.

9. An article of manufacture made by the method of claim 1.

10. An article of manufacture comprising:
a particulate material comprising surface functional groups;
a support comprising surface functional groups;
wherein surface functional groups of the particulate material are covalently attached to surface functional groups on the support via a linker group comprising the moiety:

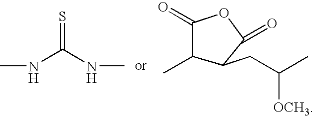

11. A method comprising:
reacting a nucleophilic group on the surface of a substrate with the compound represented by the formula: 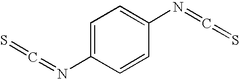
or a polymer having a moiety represented by the formula:

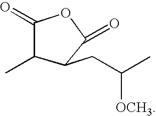

12. The method of claim 11, wherein the nucleophilic group on the surface of the substrate is an amino group.

13. An article of manufacture made by the method of claim 11.

14. An article of manufacture comprising a moiety covalently attached to a support surface, wherein the moiety is represented by the formula. 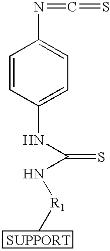
wherein R₁ represents a linking group and “SUPPORT” represents the support surface; or 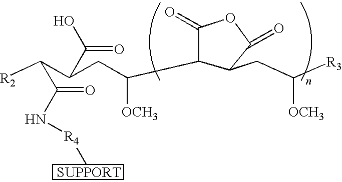
wherein n is a positive integer, “SUPPORT” represent the support surface, 1<2 is a first chemical group, R₃ is a second chemical group and R₄ is a linker group.

15. A method comprising:
(a) hybridizing an initializing oligonucleotide probe to a target polynucleotide to form a probe-target duplex, wherein the oligonucleotide probe has an extendable probe terminus, wherein the target polynucleotide is attached to a particulate material and wherein the particulate material is covalently attached to the surface of a support;
(b) ligating a first end of an extension oligonucleotide probe to the extendable probe terminus thereby forming an extended duplex containing an extended oligonucleotide probe, wherein the extension oligonucleotide probe comprises a cleavage site and a detectable label;
(c) identifying one or more nucleotides in the target polynucleotide by detecting the label attached to the just-ligated extension oligonucleotide probe;
(d) cleaving the just-ligated extension oligonucleotide probe at the cleavage site to generate the extendable probe terminus, wherein cleavage removes a portion of the just-ligated extension oligonucleotide probe that comprises the label from the probe-target duplex; and
(e) repeating steps (b), (c) and (d).

16. The method of claim 15, wherein the cleavage site can be cleaved under conditions that will not cleave phosphodiester bonds and wherein cleavage occurs under conditions that will not cleave phosphodiester bonds.

17. The method of claim 15, wherein the extension oligonucleotide probe is an octamer.

18. The method of claim 15, wherein the detectable label is a fluorescent moiety.

19. The method of claim 15, wherein a second end of the extension oligonucleotide probe opposite the first end comprises a non-extendable probe terminus.

20. The method of claim 15, wherein the extension oligonucleotide probe has a sequence as set forth below:
*NNNNN-zzz
wherein each “N” represents, independently, A, C, T or C, “z” represents a universal base, “*” represents the first end of the probe and “-” represents the cleavage site.

21. The method of claim 20, wherein the detectable label is attached to one of the universal bases.

22. The method of claim 15, wherein surface functional groups of the particulate material are covalently attached to functional groups on the support via a linker group comprising the moiety.

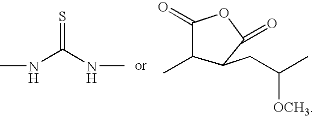

23. The method of claim 15, wherein the target nucleic acid comprises a nucleophilic group comprising one or more amino groups of the formula: 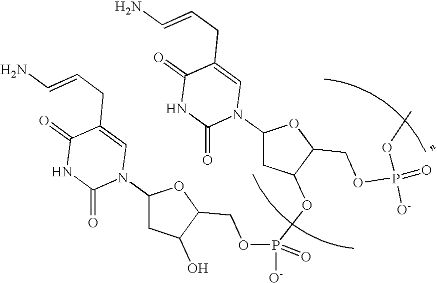
wherein n is 0 or an integer and wherein the particulate material is covalently attached to the surface of the support via reaction of one of more of the amino groups of the target nucleic acid with electrophilic groups on the surface of the support.

24. A method of sequencing a nucleic acid comprising:
(a) hybridizing a primer to a target polynucleotide to form a primer-target duplex, wherein the target polynucleotide is attached to a particulate material at a 5′ end and wherein the particulate material is covalently attached to the surface of a support;
(b) contacting the primer-target duplex with a polymerase and one or more different nucleotide analogs to incorporate a nucleotide analog onto the 3′ end of the primer thereby forming an extended primer strand, wherein the incorporated nucleotide analog terminates the polymerase reaction and wherein each of the one or more nucleotide analogs comprises (i) a base selected from the group consisting of adenine, guanine, cytosine, thymine and uracil and their analogs (ii) a unique label attached to the base or analog thereof via a cleavable linker; (iii) a deoxyribose; and (iv) a cleavable chemical group which caps an —OH group at a 3′-position of the deoxyribose;
(c) washing the surface of the support to remove any unincorporated nucleotide analogs;
(d) detecting the unique label attached to the just-incorporated nucleotide analog to thereby identify the just-incorporated nucleotide analog;
(e) optionally, permanently capping any unreacted —OH group on the extended primer strand;
(f) cleaving the cleavable linker between the just incorporated nucleotide analog and the unique label;
(g) cleaving the chemical group capping the —OH group at the 3′-position of the deoxyribose of the just incorporated nucleotide analog to uncap the —OH group;
(h) washing the surface of the support to remove cleaved compounds;
(i) repeating steps (b)-(h).
